(19) United States
(12) Patent Application Publication
(10) Pub. No.: US 2024/0029550 A1
(43) Pub. Date: Jan. 25, 2024

(54) SMART REMOTE SYSTEM

(71) Applicant: Michael Dalton Wilson, Mallorca (ES)

(72) Inventor: Michael Dalton Wilson, Mallorca (ES)

(21) Appl. No.: 18/255,445

(22) PCT Filed: Dec. 1, 2021
(86) PCT No.: PCT/EP2021/083814

§ 371 Date: Jun. 1, 2023

Related U.S. Application Data
(60) Provisional application No. 63/120,355, filed on Dec. 2, 2020.

(51) Int. Cl. G08C 17/02

(52) U.S. Cl. CPC G08C 17/02; G08C 2201/93; G08C 2201/30

(57) ABSTRACT

A smart remote system is presented which can be easily programmed for use with a variety of devices. The system includes a body having one or more sensors and a control circuit positioned within the body. The control circuit is configured to receive data from the one or more sensors and compare the received data to trigger conditions which are specified in a configuration data file. When one of the trigger conditions has been satisfied, it prompts an associated device to perform one or more actions which have been specified in the configuration file.

### CROSS REFERENCE TO RELATED PATENT APPLICATIONS

This application claims priority to U.S. Provisional Patent Application 63/120,355 filed on Dec. 2, 2020 which is fully incorporated by reference herein.

### FIELD OF THE DISCLOSURE

This disclosure generally relates to control devices. More specifically and without limitation, this disclosure relates to programmable remote control devices.

### Overview of the Disclosure

Conventional remote controls are widely utilized to remotely control various electronic devices such as garage doors, television sets and door locks on vehicles, to name a few. While the capability, range, durability and functionality of remote controls have improved over time, substantial deficiencies still exist in the art. One deficiency with current remote technologies is that conventional remote controls are limited to a predetermined set of actions or operations that may be remotely triggered by a user by pressing inputs on the remote. This deficiency is exasperated by the desire for more intelligent automation and control of devices to provide enhanced usability from a user perspective. These limited systems do not provide the ability to easily expand functionality and/or capabilities of the devices.

Thus, it is a primary object of the disclosure to provide a smart remote system that improves upon the state of the art.

Another object of the disclosure to provide a remote control system having one or more sensors that can be used to trigger actions of a remote controlled device.

Yet another object of the disclosure is to provide a remote control system capable of independently controlling different remote controlled devices.

Another object of the disclosure is to provide a remote control system that can be programed to control third party remote controlled devices;

Yet another object of the disclosure is to provide a remote control system that can be programed to trigger various actions specified by a user in response to sensor data satisfying trigger conditions specified by the user;

Another object of the disclosure is to provide a remote control system that is power efficient.

Yet another object of the disclosure is to provide a remote control system that is user friendly.

Another object of the disclosure is to provide a remote control system that provides improved functionality.

Yet another object of the disclosure is to provide a remote control system that is easy to program.

Yet another object of the disclosure is to provide a remote control system that is relatively inexpensive.

Another object of the disclosure is to provide a remote control system that has a minimum number of parts.

Yet another object of the disclosure is to provide a remote control system that has an intuitive design.

Another object of the disclosure is to provide a remote control system that is intuitive to install.

Yet another object of the disclosure is to provide a remote control system that has an installation that is quick.

Another object of the disclosure is to provide a remote control system that expands functionality of remote controlled devices.

Yet another object of the disclosure is to provide a remote control system that is durable.

Another object of the disclosure is to provide a remote control system that has a long useful life.

These and other objects, features, or advantages of the present disclosure will become apparent from the specification, claims and drawings.

### BRIEF DESCRIPTION OF THE DRAWINGS

FIG. 1 shows an embodiment of the present system installed on a window; this embodiment including a remote controlled device and control unit installed on the upper portion of the window and a smart remote.

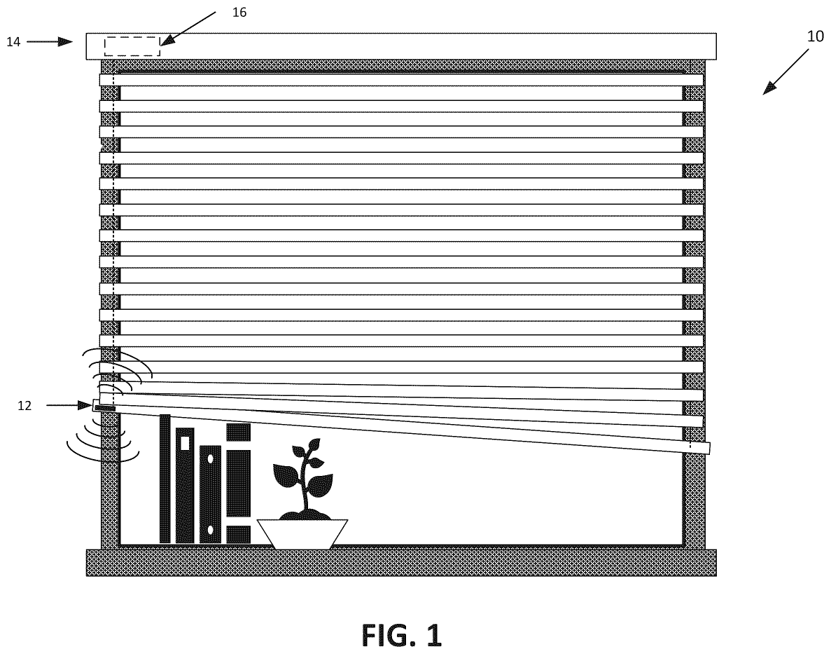

FIG. 2 shows a diagram of the smart remote of the system; wherein the smart remote houses the control circuit, power source, user interface, and sensors. A configuration file and computer code or instructions is stored within the memory of the control circuit. Also located in the control circuit is a communication circuit, an antenna, and a processing circuit.

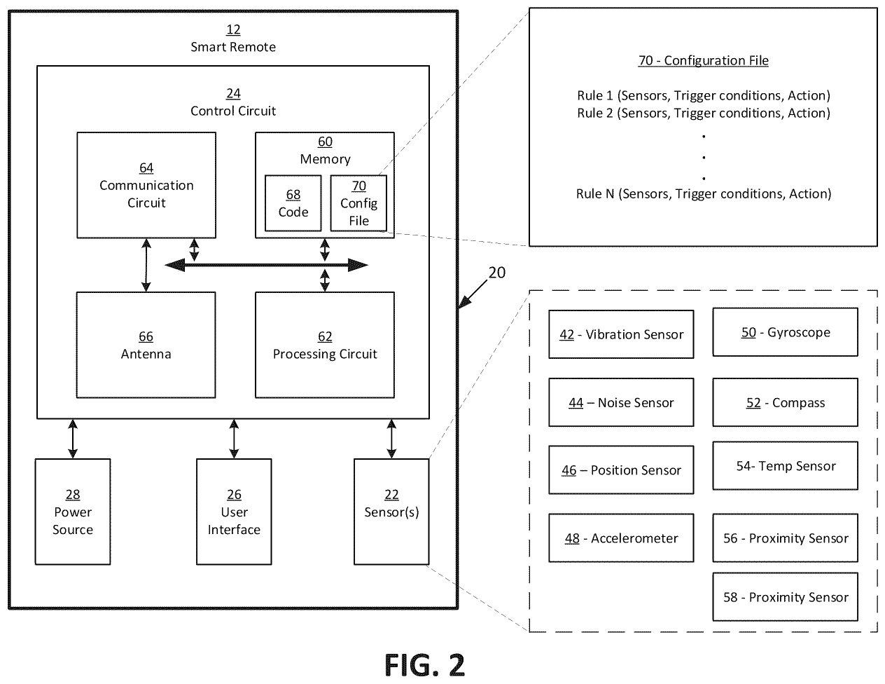

FIG. 3 shows a diagram of a system configured to power on, receive data, compare data to a configuration file, respond to a specified trigger condition, and perform a specified action that corresponds to the specified trigger condition.

FIG. 4 shows a diagram of a system configured to power on, receive data, compare data to a configuration file, respond to a trigger condition, perform a specified action that corresponds to the specified trigger condition, enter a sleep mode, and power back on if activity is detected.

FIG. 5 shows a diagram of a system configured to start, provide an interface for selecting sensors, provide an interface for selecting trigger conditions for selected sensors, provide an interface for selection of a specified device, provide an interface for selecting an action to be performed, and create a rule in a configuration data file for the selected sensors, trigger conditions, devices, and actions.

FIG. 6 is a perspective view of a nonlimiting embodiment of the smart remote device of FIG. 2 showing a user interface.

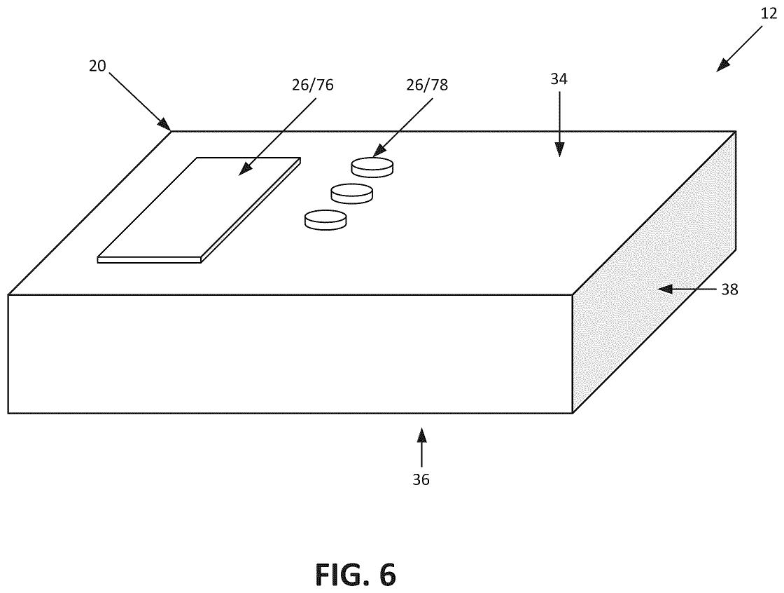

FIG. 7 is a transparent perspective view of a nonlimiting embodiment of the smart remote device of FIG. 2 which displays a power source, control circuit, sensors, and antenna housed within the body of the smart remote device.

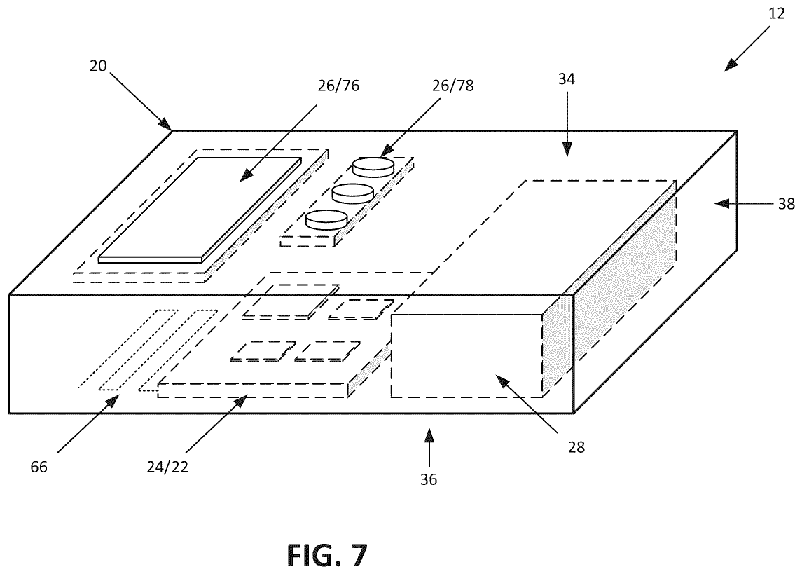

FIG. 8 shows a nonlimiting embodiment of the remote control device; wherein a control unit and power source are house within the remote controlled device. Computer code is stored inside the memory of the control unit. The control unit also includes a communication circuit, an antenna, and a processing circuit.

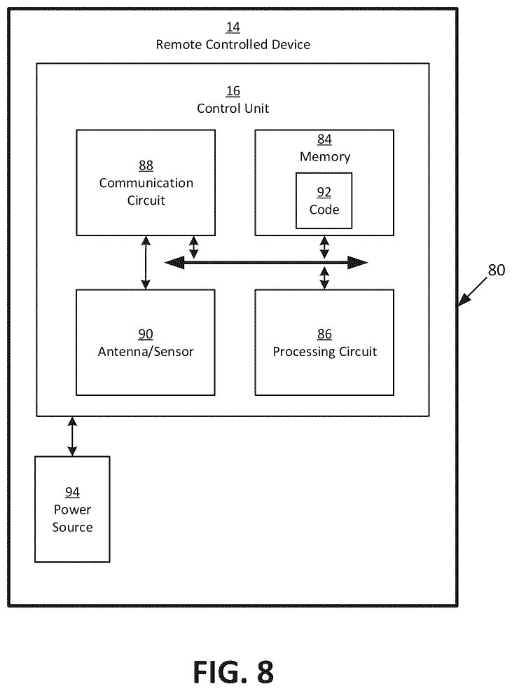

### SUMMARY OF THE DISCLOSURE

In one or more arrangements, a smart remote system is provided. The system includes a smart remote with a body having a front side, a back side, and an exterior peripheral edge, one or more sensors positioned within in the body, and a control circuit positioned within in the body. The control circuit is communicatively connected to the one or more sensors. The control circuit is configured and arranged to receive data from the one or more sensors and compare the data to one or more trigger conditions specified in a configuration data file. In response to the data satisfying a first trigger condition of the one or more trigger conditions, the control circuit is configured to perform one or more actions specified in the configuration data file for the first trigger condition. In one or more arrangements, the smart remote system includes a user interface. The user interface is configured to permit a user to specify, in the configuration data file, pairs of trigger conditions and actions to be performed when trigger conditions are satisfied.

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of controlling remote controlled devices. However, the embodiments are not so limited. It is appreciated that the embodiments may be adapted for use in other applications which may be improved by the disclosed structures, arrangements and/or methods. The system is merely shown and described as being used in in the context of controlling remote controlled devices for ease of description and as one of countless examples.

### System 10:

With reference to the figures, a remote control system 10 (system 10) is presented. System 10 is formed of components of any suitable size, shape, design, technology, and in any arrangement or configuration to facilitate wireless control of one or more devices in response to measurements of one or more sensors of system 10. In one or more embodiments, system 10 includes one or more remote controlled devices 14 and a smart remote 12 configured to perform user customized control of the remote controlled devices 14 in response to sensors 22 of smart remote 12.

### Smart Remote 12:

Smart remote 12 is formed of components of any suitable size, shape, design, technology, and in any arrangement or configuration and is configured to facilitate user customized control of remote controlled devices 14 in response to sensors 22 of smart remote 12. In the arrangement shown, as one example, smart remote 12 includes a body 20, sensors 22, a control circuit 24, a user interface 26, a power source 28 among other components.

Body 20:

In one or more shown arrangements, for example, remote control 12 includes a body 20. Body 20 may be any suitable size, shape, design suitable to house components of smart remote 12 and facilitate deployment and/or user operability. In one or more arrangements shown, as one example, body 20 includes a front side 34, a back side 36, and an exterior peripheral edge 38, formed by sides of body 20, which is generally square to the planes formed by the front and back sides 34/36 smart remote 12. In one or more arrangements, body 20 is formed of a solid structure molded around other components of smart remote 12. Alternatively, in one or more arrangements, front side 34, back side 36, and exterior peripheral edge 38 of body 20 form a hollow interior configured to house the other components of smart remote 12.

Sensors:

In one or more arrangements, smart remote 12 includes and/or is communicatively connected to a plurality of sensors 22. Sensors 22 are formed of any suitable size, shape, design, technology, and in any arrangement and are configured to detect various environmental characteristics. Any number of sensors 22 are connected to, incorporated within, or used in association with smart remote 12. In one arrangement shown, as one example, sensors 22 include a vibration sensor 42, noise sensor 44, position sensor 46, such as GPS or the like, an accelerometer 48, a gyroscope 50 or tilt sensor, a compass 52, a temperature sensor 54 and any other sensor that provides information movement of or surrounding of smart remote 12.

In this example arrangement, wherein a vibration sensor 42 is used in association with the system 10, vibration sensor 42 is formed of any suitable size, shape, design, technology, and in any arrangement and is either incorporated within smart remote 12 or is attached as a separate component that is external to and communicatively connected to smart remote 12. Vibration sensor 42 senses the vibrations of smart remote 12. In one arrangement, vibration sensor 42 is capable of sensing and detecting the displacement, velocity and acceleration associated with the vibrations the smart remote 12 experiences. In one arrangement, vibration sensor 42 is capable of sensing vibrations within any vibration range and frequency range and reporting the range and frequency of the vibration to control circuit 24 of smart remote 12. In one arrangement, vibration sensor 42 is capable of detecting the directionality of vibrations in the X, Y and Z directions (X being forward to back, Y being left to right, and Z being up and down). In different arrangements, vibration sensor 42 may be analog or digital. The information detected by vibration sensor 42 is transmitted to control circuit 24 for storage or processing, and/or transmitted through an electronic network to the cloud, internet and/or remote database for storage and/or further analysis as a component to assist with evaluation of sensor data.

One component of some vibration analysis is sensing acceleration. As such, in some arrangements, an accelerometer serves as a vibration sensor. In other arrangements, a separate vibration sensor and an accelerometer are separate components. In the arrangement wherein a vibration sensor 42 and a separate accelerometer 48 are used, accelerometer 48 is formed of any suitable size, shape, design, technology and in any arrangement, and is either incorporated within smart remote 12 or is attached as a separate component that is external to and communicatively connected to smart remote 12. Accelerometer 48 senses acceleration or proper acceleration being the acceleration (or rate of change of velocity) of a body in its own instantaneous rest frame. In one arrangement, accelerometer 48 is an electromechanical device that measures acceleration forces, which may be static, such as the constant force of gravity, or they may be dynamic such as that caused by moving or vibrating the accelerometer 48. Accelerometer 48 may be sensor that measures the dynamic acceleration of a physical device as a voltage. Accelerometer 48 may be analog or digital and may be a one-axis, a two-axis or three-axis accelerometer (for three dimensional positioning) or two two-axis accelerometers mounted at ninety degrees to one another, or three one-dimensional accelerometers mounted at ninety degrees to one another, or any combination thereof. In one arrangement, accelerometer 48 uses the piezoelectric effect, meaning it contains microscopic crystal structures that get stressed by accelerative forces, which causes a voltage to be generated which is interpreted as acceleration. In another arrangement, accelerometer 48 senses changes in capacitance between two proximate microstructures, which when they are moved relative to one another capacitance changes, which is interpreted as acceleration. However, any other form of an accelerometer is hereby contemplated for use. The information detected by accelerometer 48 is transmitted to control circuit 24 for storage and/or processing and/or is transmitted through an electronic network to the cloud, internet and/or remote database for storage and/or further analysis as a component to assist with evaluation of sensor data.

In one arrangement, vibration sensor 42 and/or accelerometer 48 may take the form of a seismometer or seismograph which tracks vibration and/or motion of one object relative to another.

In one or more arrangements wherein a gyroscope 50 or a tilt sensor 50 is used in association with the smart remote 12, gyroscope 50 is formed of any suitable size, shape, design, technology, and in any arrangement or configuration and is either incorporated within smart remote 12 or is attached as a separate component that is external to and communicatively connected to smart remote 12. Gyroscope 50 senses and/or measures the orientation and/or angular velocity of smart remote 12 and operates based on the principles of conversation of angular momentum. Gyroscope 50 may be a mechanical gyroscope, or an electronic gyroscope. When a mechanical gyroscope 50 is used it includes a gyroscope frame, a gimbal, a rotor and a spin axis that allows freedom of rotation in all three axes allowing the rotor to maintain its spin axis direction regardless of the orientation of the outer frame. When an electronic gyroscope 50 is used it may take one of many forms. One form of an electronic gyroscope is what is known as a microelectromechanical systems (MEMS) gyroscope which is a miniaturized gyroscope found in electronic devices which takes the idea of the Foucault pendulum and uses a vibrating element. When a MEMS gyroscope is rotated, a small resonating mass is shifted as the angular velocity changes. This movement is converted into very low-current electrical signals that can be amplified and read by a host microcontroller. Another form of an electronic gyroscope is what is known as a hemispherical resonator gyroscope (HRG), also called wine-glass gyroscope or mushroom gyro, which operates using a thin solid-state hemispherical shell, anchored by a thick stem. This shell is driven to a flexural resonance by electrostatic forces generated by electrodes which are deposited directly onto separate fused-quartz structures that surround the shell. Gyroscopic effect is obtained from the inertial property of the flexural standing waves. Another form of an electronic gyroscope is what is known as a vibrating structure gyroscope (VSG), also called a Coriolis vibratory gyroscope (CVG), which uses a resonator made of different metallic alloys. It takes a position between the low-accuracy, low-cost MEMS gyroscope and the higher-accuracy and higher-cost fiber optic gyroscope. Accuracy parameters are increased by using low-intrinsic damping materials, resonator vacuumization, and digital electronics to reduce temperature dependent drift and instability of control signals. Another form of an electronic gyroscope is what is known as a dynamically tuned gyroscope (DTG) which is a rotor suspended by a universal joint with flexure pivots. The flexure spring stiffness is independent of spin rate. However, the dynamic inertia (from the gyroscopic reaction effect) from the gimbal provides negative spring stiffness proportional to the square of the spin speed. Therefore, at a particular speed, called the tuning speed, the two moments cancel each other, freeing the rotor from torque, a necessary condition for an ideal gyroscope. Another form of an electronic gyroscope is what is known as a ring laser gyroscope which relies on the Sagnac effect to measure rotation by measuring the shifting interference pattern of a beam split into two halves, as the two halves move around the ring in opposite directions. Another form of an electronic gyroscope is what is known as a fiber optic gyroscope which uses the interference of light to detect mechanical rotation. The two halves of the split beam travel in opposite directions in a coil of fiber optic cable and makes use of the Sagnac effect. Another form of an electronic gyroscope is what is known as a London moment gyroscope which relies on the quantum-mechanical phenomenon, whereby a spinning superconductor generates a magnetic field whose axis lines up exactly with the spin axis of the gyroscopic rotor. A magnetometer determines the orientation of the generated field, which is interpolated to determine the axis of rotation. Any other form of a gyroscope or gyrostat is hereby contemplated for use as gyroscope 50. The information detected by gyroscope is transmitted to control circuit 24 for storage and/or processing and/or is transmitted through an electronic network to the cloud, internet and/or remote database for storage and/or further analysis as a component to assist with evaluation of sensor data.

In one or more arrangements wherein a compass 52 is used in association with the smart remote, compass 52 is formed of any suitable size, shape, design, technology, and in any arrangement or configuration and is either incorporated within smart remote 12 or is attached as a separate component that is external to and communicatively connected to smart remote 12. Compass 52 is any device that senses the relative direction and/or direction of travel of smart remote 12. Compass 52 may be formed of a magnetic compass, a gyrocompass, a solid state compass, a GPS compass which uses GPS information to determine direction, or any other form of a compass. In one arrangement, compass 52 is an electronic compass that uses Hall Effect sensors and a magnetic concentrator formed of a disk of high permeability material to detect magnetic fields from which direction is determined. The information detected by compass 52 is transmitted to control circuit 24 for storage and/or processing and/or is transmitted through an electronic network to the cloud, internet and/or remote database for storage and/or further analysis as a component to assist with evaluation of sensor data.

In one or more arrangements wherein a position sensor 46 is used in association with the smart remote 12, position sensor 46 is formed of any suitable size, shape, design, technology, and in any arrangement or configuration and is either incorporated within smart remote 12 or is attached as a separate component that is external to and connected to smart remote 12. Position sensor 46 is any device that senses the position and/or direction of travel of smart remote 12. In one arrangement, position sensor 46 is a Global Positioning System (GPS) sensor which is a radio-navigation system that provides geolocation and time information to a GPS receiver anywhere on or near the Earth where there is an unobstructed line of sight to three or more GPS satellites using trilateration. In another arrangement, position sensor 46 is what is known as an Assisted GPS system (AGPS) which uses GPS information in conjunction with position information from cell phone towers and WIFI networks to calculate position. Alternatively, in one arrangement, position sensor 46 uses only signals from terrestrial points, such as cell phone towers and WIFI networks to calculate position. The information detected by position sensor 46 is transmitted to control circuit 24 for storage and/or processing and/or is transmitted through an electronic network to the cloud, internet and/or remote database for storage and/or further analysis as a component to assist with evaluation of sensor data.

In one or more arrangements a noise sensor 44 is used in association with the smart remote 12, noise sensor 44 is formed of any suitable size, shape, design, technology, and in any arrangement or configuration and is either incorporated within smart remote 12 or is attached as a separate component that is external to and communicatively connected to smart remote 12. Noise sensor 44 is any device that senses noises during operation of smart remote 12. Noise sensor 44 may detect the volume, pitch, frequency, cadence or any other information regarding the noise within smart remote 12. In one arrangement, noise sensor 44 is a microphone, or a plurality of microphones. The information detected by noise sensor 44 is transmitted to control circuit 24 for storage and/or processing and/or is transmitted through an electronic network to the cloud, internet and/or remote database for storage and/or further analysis as a component to assist with evaluation of sensor data.

In one or more arrangements, a temperature sensor 54 is also used in association with the smart remote 12. Temperature sensor 54 is formed of any suitable size, shape, design, technology, and in any arrangement or configuration and is either incorporated within smart remote 12 or is attached as a separate component that is external to and communicatively connected to smart remote 12. Temperature sensor 54 is any device that senses temperature during operation of smart remote 12. Temperature sensor 54 may directly detect temperature, such as a thermometer. Alternatively, temperature sensor 54 may provide temperature through connectivity to a temperature providing device, system or service, such as the national weather service, the internet or the like. The information detected by temperature sensor 54 is transmitted to control circuit 24 for storage and/or processing and/or is transmitted through an electronic network to the cloud, internet and/or remote database for storage and/or further analysis as a component to assist with evaluation of sensor data.

In one or more arrangements, a proximity sensor 56 is also used in association with the smart remote 12. Proximity sensor 56 is formed of any suitable size, shape, design, technology, and in any arrangement or configuration and is either incorporated within smart remote 12 or is attached as a separate component that is external to and communicatively connected to smart remote 12. Proximity sensor 56 is any device that is indicative of proximity of objects to smart remote 12. Proximity sensor 56 may include, for example, inductive proximity sensors, optical proximity sensors, capacitive proximity sensors, ultrasonic proximity sensors, and/or any other type of proximity sensor. The information detected by proximity sensor 56 is transmitted to control circuit 24 for storage and/or processing and/or is transmitted through an electronic network to the cloud, internet and/or remote database for storage and/or further analysis as a component to assist with evaluation of sensor data.

In one or more arrangements, a motion sensor 58 is also used in association with the smart remote 12. Motion sensor 58 is formed of any suitable size, shape, design, technology, and in any arrangement or configuration and is either incorporated within smart remote 12 or is attached as a separate component that is external to and communicatively connected to smart remote 12. Motion sensor 58 is any device that detects motion of objects. Motion sensor 58 may include, for example, passive infrared sensors, microwave motion sensors, dual technology motion sensors, area reflective motion sensors, ultrasonic motion sensors, vibration motion sensors, and/or any other type of motion sensor. The information detected by motion sensor 58 is transmitted to control circuit 24 for storage and/or processing and/or is transmitted through an electronic network to the cloud, internet and/or remote database for storage and/or further analysis as a component to assist with evaluation of sensor data.

Control Circuit 24:

Control circuit 24 is formed of any suitable size, shape, design, technology, and in any arrangement and is configured to control operation of other components of smart remote 12 to facilitate triggering of user customized actions in response to signals of sensors 22. In the arrangement shown, as one example implementation, smart remote 12 control circuit 24 includes a processing circuit 62 and memory 60 having software code 68 or instructions that facilitates the computational operation of smart remote 12. Processing circuit 62 may be any computing device that receives and processes information and outputs commands according to software code 68 or instructions and configuration data file 70 stored in memory 60.

Memory 60 may be any form of information storage such as flash memory, ram memory, dram memory, a hard drive, or any other form of memory. Processing circuit 62 and memory 60 may be formed of a single combined unit. Alternatively, processing circuit 62 and memory 60 may be formed of separate but electrically connected components. Alternatively, processing circuit 62 and memory 60 may each be formed of multiple separate but electrically connected components.

Software code 68 or instructions is any form of information or rules that direct processing circuit 62 how to receive, interpret and respond to information to operate as described herein. Software code 68 or instructions is stored in memory 60 and accessible to processing circuit 62. As an illustrative example, in one or more arrangements, software code or instructions may configure processing circuit 62 of smart remote 12 to perform the following steps: 1) acquire data from one or more sensors 22; 2) determine if any trigger conditions in configuration data file 70 are satisfied by the sensor data; and 3) if a trigger condition is satisfied, perform the operation(s) specified for the trigger condition in the configuration data file 70.

Configuration data file 70 is any form of information that indicates conditions in which smart remote 12 is to perform actions in response to sensor data and which actions are to be performed. In the arrangement shown, configuration data file 70 is configured and arranged as a set of rules, where each rule indicates a set of conditions and one or more actions to be performed when the conditions are satisfied. However, it is contemplated that smart remote 12 may be configured to utilize a configuration data file 70 with any configuration, arrangement, format, or structure. In some various arrangements, actions may include but are not limited to, transmitting commands (e.g., a remote control command) to a control unit 16 of one or more remote controlled devices 14, providing status messages and/or sensor data to one or more devices, providing alert messages to one or more users or devices, and/or any other action.

Communication Circuit 64:

Communication circuit 64 is formed of any suitable size, shape, design, technology, and in any arrangement and is configured to facilitate communication with devices to be controlled, monitored, and/or alerted by smart remote 12. In one or more arrangements, as one example, communication circuit 64 is a includes a transmitter (for one way communication) or transceiver (for two way communication). In the arrangement shown, as one example, communication circuit 64 is connected to antenna 66, which may be a monopole antenna, dipole antenna, a loop antenna, a fractal antenna, or any other form of an antenna, to facilitate transmission and/or reception of signals in the form of electromagnetic radio frequencies. Additionally or alternatively, in one or more arrangements, communication circuit may be connected to a light emitting diodes (or other light emitting device) and/or a light sensor to facilitate communication of signals using light (e.g., infrared communication). Although the disclosed arrangements are primarily described with reference to wireless communication by smart remote 12, the embodiments are not so limited. Rather, it is contemplated that in various arrangements, communication circuit 64 may be configured to communicate using various wired and/or wireless communication technologies and protocols over various networks and/or mediums including but not limited to, for example, RFID, Near Field Communication (NFC), infrared and optical communication, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HSPA+/HSDPA, CDMA, LTE, FM/VHF/VHF/UHF networks, and/or any other communication protocol, technology or network.

User Interface 26:

User Interface is formed of any suitable size, shape, design, technology, and in any arrangement and is configured to facilitate user customization of triggering conditions and actions to be performed by smart remote 12. In one or more arrangements, as one example, user interface includes a display 76 and a set of inputs 78. Display 76 is formed of any suitable size, shape, design, technology, and in any arrangement and is configured to facilitate display of graphical user interface and/or patient medical records. In one or more arrangements, display 76 may be, for example, a screen or monitor of a computing device, tablet, and/or smartphone.

Inputs 78 are formed of any suitable size, shape and design and are configured to facilitate user input of data and/or control commands. In one or more arrangements, inputs 78 includes a plurality of buttons that are pressed by a user. In an alternative arrangement, as one example, at least one input 78 and display 76 are combined as a touch screen display that facilitates the entry of information by interaction with a touch screen and facilitate display of a graphical user interface and/or patient medical records. In another alternative arrangement, as one example, the inputs 78 include a keyboard, mouse and/or GUI (graphical user interface). In an alternative arrangement, as one example, the inputs 78 include a joystick, a roller ball, a knob, or any other form of an input.

Additionally or alternatively, in one or more arrangements, the inputs 78 and/or display may be implemented on a separate device that is communicatively connected to smart remote 12. For example, in one or more arrangements, operation of smart remote 12 may customized using a smartphone or other computing device that is communicatively connected to the smart remote 12 (e.g., via Bluetooth, WIFI, and/or the internet). An app on the smartphone or computing device may provide a user interface configured to facilitate user customization of the operation of smart remote 12,

Power Source 28:

In the arrangement shown, as one example, smart remote 12 includes a power source 28. Power source 28 is formed of any suitable size, shape, design, technology, and in any arrangement or configuration and is configured to provide power to smart remote 12 so as to facilitate the operation of the electrical components of the smart remote 12. In the arrangement shown, as one example, power source 28 is formed of one or more batteries, which may or may not be rechargeable. Additionally or alternatively, in one or more arrangements, power source 28 may include a solar cell or solar panel that may power or recharge smart remote 12. Additionally or alternatively, in one or more arrangements, power source 28 may be line-power that is power that is delivered from an external power source into the smart remote 12 through a wired connection. Additionally or alternatively, in one or more arrangements, power source 28 may be a wireless power delivery system configured to power or recharge smart remote 12. Any other form of a power source 28 is hereby contemplated for use.

### Remote Controlled Device(s) 14:

Smart remote 12 is thought to be applicable for use to control a wide variety of different remote controlled devices 14. Remote controlled devices are formed of components of any suitable size, shape, design, technology, and in any arrangement or configuration and is configured to perform various operations or tasks in response to command signals from a remote control (e.g., an OEM remote control). In the arrangement shown, as one example, smart remote 12 includes at least a housing 80, a control unit 16, and a power source 94 among other components.

Housing 80:

In one or more arrangements, for example, remote controlled device 14 includes a housing 80. Housing 80 may be any suitable size, shape, design suitable to house components of remote controlled device 14 and facilitate deployment and/or user operability. In one or more arrangements, for example, housing 80 may form a hollow enclosure configured to contain control unit 16, power source 94 and other components of the remote controlled device within the hollow enclosure.

Control Unit 16:

Control unit 16 is formed of any suitable size, shape, design, technology, and in any arrangement and is configured to control operation of other components of remote controlled device 14 to perform or cause other components of remote controlled device 14 to perform various operations or tasks in response to control signals received by communication circuit 88. In the arrangement shown, as one example, control unit 16 of remote controlled device 14 includes a memory 84, a processing circuit 86, a communication circuit 88, and an antenna/sensor 90.

Processing Circuit 86 and Memory 84:

In the arrangement shown, as one example implementation, control unit 16 of remote controlled device 14 includes a processing circuit 86 and memory 84 having software code 92 or instructions that facilitates the computational operation of remote controlled device 14. In one or more arrangements processing circuit 86 and memory 84 are similar to processing circuit 62 and memory 60 of control circuit 24 of smart remote 12, with the difference being that processing circuit 86 is configured to perform different operations by a different set of code 92. More specifically, when code 92 is executed by processing circuit 86, processing circuit 86 performs or causes other components of remote controlled device 14 to perform various operations or tasks in response to control signals received by communication circuit 88.

Communication Circuit 88 and Antenna 90:

Communication circuit 88 is formed of any suitable size, shape, design, technology, and in any arrangement and is configured to facilitate reception of control signals communicated from a remote controller (e.g., an OEM remote or smart remote 12). In one or more arrangements, as one example, communication circuit 88 is a includes a receiver (for one way communication) or transceiver (for two way communication). In the arrangement shown, as one example, communication circuit 88 is connected to antenna/sensor 90, which may be a monopole antenna, dipole antenna, a loop antenna, a fractal antenna, or any other form of an antenna, to facilitate transmission and/or reception of signals in the form of electromagnetic radio frequencies. Additionally or alternatively, in one or more arrangements, antenna/sensor 90 may be a sensor configured to facilitate reception of signals using light (e.g., infrared communication). Although the disclosed arrangements are primarily described with reference to wireless communication by remote controlled device 14, the embodiments are not so limited.

In one or more arrangements, communication circuit 88 is configured to receive command signals using various wired and/or wireless communication technologies and protocols over various networks and/or mediums including but not limited to, for example, RFID, Near Field Communication (NFC), infrared and optical communication, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HPA+/HSDPA, CDMA, LTE, FM/VHF/UHF networks, and/or any other communication protocol, technology or network.

Power Source 94:

In the arrangement shown, as one example, remote controlled device 14 includes a power source 94. Power source 94 is formed of any suitable size, shape, design, technology, and in any arrangement or configuration and is configured to provide power to control unit 16 of remote controlled device 14 so as to facilitate the operation of the electrical components of control unit 16. In the arrangement shown, as one example, power source 94 is formed of one or more batteries, which may or may not be rechargeable. Additionally or alternatively, in one or more arrangements, power source 94 may include a solar cell or solar panel that may power or recharge remote controlled device 14. Additionally or alternatively, in one or more arrangements, power source 94 may be line-power that is power that is delivered from an external power source into the remote controlled device 14 through a wired connection. Additionally or alternatively, in one or more arrangements, power source 94 may be a wireless power delivery system configured to power or recharge remote controlled device 14. Any other form of a power source 94 is hereby contemplated for use. In one or more arrangements, power source 94 may power control unit 16 along with other components of remote controlled device 14. Alternatively, in some arrangements, control unit 16 may be powered by power source 94 and other components of remote controlled device 14 may be independently powered by a separate power source.

### In Operation:

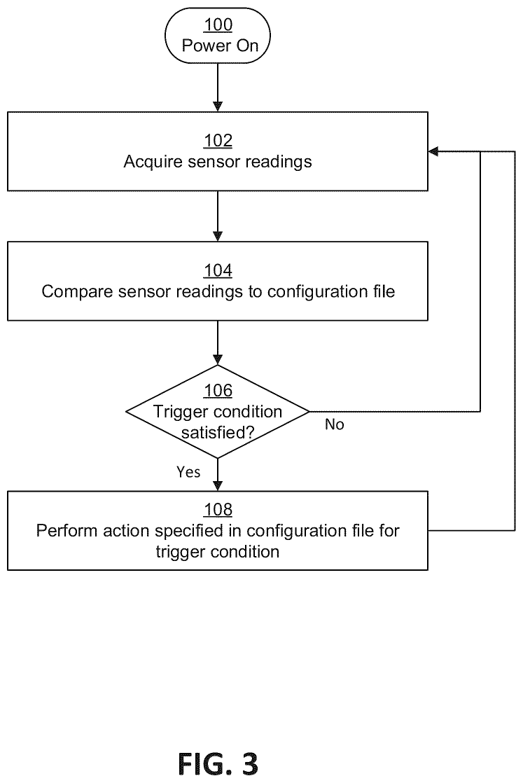

In various arrangements, smart remote 12 may utilize various different processes to control or provide alerts to devices in response to data of sensors 22. FIG. 3 shows an example process that may be performed by smart remote 12 to control or provide alerts to devices in response to data of sensors 22. In this example, the process is initiated when smart remote is powered on at process start 100. At process block 102, smart remote 12 acquires data from sensors 22. At process block 104, the sensor data are compared to rules in the configuration data file 70. If one or more of the rules in configuration data file 70 are satisfied, the process proceeds from decision block 106 to process block 108, where the smart remote 12 performs actions specified for the rule in the configuration data file 70.

As one illustrative example, actions performed at process block 108 may include causing communication circuit 64 to transmit a particular control signal specified in the configuration data file 70 to remote controlled device 14. When received by antenna/sensors 90 and communication circuit 88 of control unit 16 of remote controlled device 14, communication circuit 88 provides a signal indicative of the control signal to process circuit 86. Code 92 executed by processing circuit 86 causes processing circuit 86 to perform and trigger another component of remote controlled device 14 to perform an operation or task associated with the control signal. After performing the specified action at process block 108, or if none of the rules in configuration data file 70 are satisfied at decision block 106, the process returns to process block 102 and the process is repeated.

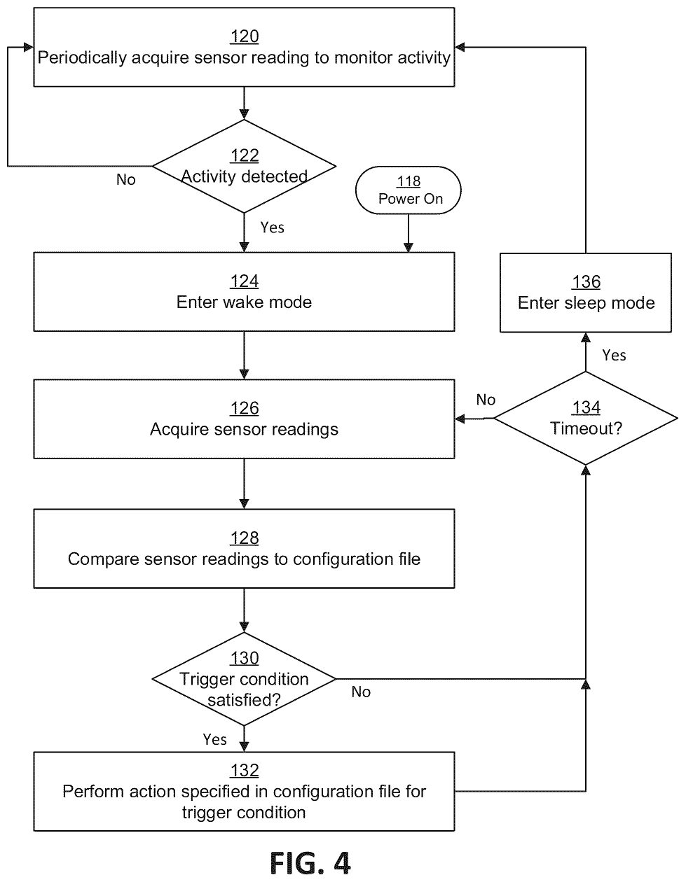

FIG. 4 shows another example process that may be performed by smart remote 12 to control or provide alerts to devices in response to data of sensors 22. In this example, the process is configured to operate smart remote 12 in a low power or sleep mode when sensors are not indicative of any activity.

In this example, the process is initiated when smart remote 12 is powered on at process start 118. In this example, the process enters a wake mode at process block 142 when initiated. When entering the wake mode smart remote may power on one or more circuits (e.g., communication circuits) that are powered off in sleep mode and/or switch one or more circuits from a lower power mode to a higher power mode.

The process acquires data from sensors 22 at process block 126. At process block 128, the sensor data is compared to rules in the configuration data file 70. If one or more of the rules in configuration data file 70 are satisfied, the process proceeds from decision block 130 to process block 132, where the smart remote 12 performs actions specified for the rule in the configuration data file 70. After performing the specified action at process block 132, or if none of the rules in configuration data file 70 are satisfied at decision block 106, the process proceeds to decision block 134. While sensor data continues to indicate activity, the process returns from decision process block 134 to 126, where additional sensor data is acquired. The process loops in this manner through process blocks 126, 128, 130, 132 until no activity has been detected for a threshold period of time. In other words, the process continues in this manner until a time out occurs.

When a time out occurs, the process proceeds from decision block 134, to process block 136, where smart remote 12 enters a sleep mode. When entering sleep mode, smart remote may power off one or more circuits and/or transition one or more circuits to a lower power mode. After entering sleep mode, the process proceeds to process block 120, where sensor data is acquired. In one or more, arrangements, smart remote 12 may save power by acquiring data from sensors 22 less frequently when operating in sleep mode (e.g., at process block 120) in comparison to when operating in wake mode (e.g., at process block 126). The process loops at process block 120 and decision block 122 until activity is detected, at which time the process proceeds back to process block 124, where it again enters wake mode.

### User Customization of Smart Remote:

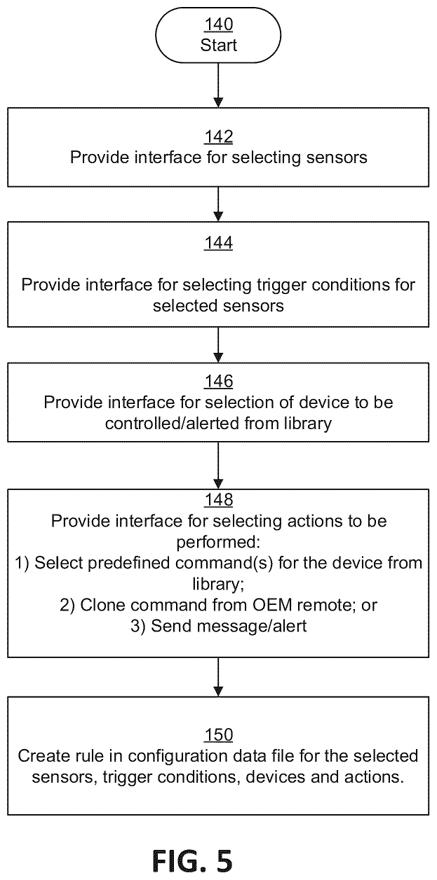

In various arrangements, smart remote 12 may utilize various different processes to facilitate user customization of operations performed by smart remote 12. FIG. 5 shows one example process for customization of operations performed by smart remote, in accordance with one or more embodiments. In this example, process is initiated at process start 140. At process block 142, an interface is provided for a user to select one or more sensors 22 to be used to trigger the desired action(s). At process block 144, an interface is provided for a user to select trigger conditions for performance of a desired action based on data from the selected sensors. Trigger conditions may include, for example, Boolean sensor states, various Boolean function based on of sensor values (e.g., threshold value triggers), and/or Boolean logic functions function of a combination of Boolean sensor states and/or Boolean functions. However, embodiments are not so limited. Rather, it is contemplated that in some various embodiments, trigger conditions may be specified in any configuration, arrangement, format, or structure. At process block 146, an interface is provided for a user to select one or more devices to be controlled or alerted when the selected trigger conditions are satisfied.

At process block 148, an interface is provided for a user to select actions to be performed when the selected trigger conditions are satisfied. In the example process shown, the interface provides the user option to select predefined commands for the selected device from a library. Such predefined commands may correspond, for example, to commands used by an OEM remote control for the selected device. In the example process shown, the interface also provides the user the option to clone a command from an OEM remote. For example, a user may press a desired command on an OEM remote control, when prompted by the process, which is recorded and stored in memory 60 of control circuit 24.

In the example process shown, the interface also provides a user the option to prompt an alert message to be sent to the selected device when the trigger condition is satisfied. In this case, the selected device may be specified as an email address, phone number, social media handle, or other identifier. In some various arrangements, such alert messages may include but are not limited to emails, text messages, instant messages, tweets, phone calls, and/or any other type of electronic messaging.

After user selection of actions to be performed is completed at process block 148, the process proceeds to process block 150. At process block 150, a rule is created in the configuration data file 70 that indicates the sensors, trigger conditions, devices, and actions selected by the user.

Example User Applications:

Smart remote 12 is thought to be applicable to a wide variety of user applications. As an illustrative example, smart remote 12 may be configured to provide user customized automated control of a motorized window shade or set of blinds. For instance, the user may utilize smart remote to prevent an automated window shade or set of blinds from contacting decorative objects placed on a windowsill. Such contact may cause a bottom rail of a window shade to tilt which may cause unsightly ripples in the shade. Further, such contact may cause the decorative objects to be knocked over and broken. As an example solution, a user may attach smart remote 12 to the bottom bar and configure smart remote 12 to communicate control signals to control unit 16 of motorized window shade or set of blinds to cause the automated window shade or set of blinds to halt and retract a certain amount if gyroscope 50 indicates smart remote is tilting (e.g., due to contract of the bottom bar with a decorative object on the window sill). In one arrangement, smart remote 12 is adhered to the bottom bar. Additionally or alternatively, the user may configure the smart remote 12 to communicate control signals to control unit 16 to cause the motorized window shade or set of blinds to retract the window shade or blinds when gyroscope indicates an amount of motion exceeding a predetermined threshold (e.g., which may be indicative of the window shade or set of blinds being blown about by high winds).

As another illustrative example, smart remote 12 may be configured to provide user customized automated control of a remote operated boat lift. Boat lifts are used to lift and hold a boat out of a body of water, Typically, the boat is lifted to an elevation to keep the boat above high tide. However, care must be taken to lift to a suitable elevation since the tide levels vary throughout the year. During especially high tides (e.g., the King tides) or storm surges, a boat owner may need to further lift the boat to keep water from lifting the boat off of the boat lift. As an example solution, a boat owner may place smart remote 12 in their lifted boat and configure smart remote 12 to communicate control signals to control unit 16, if gyroscope 50 indicates smart remote is tilting (e.g., due to pitch yaw or roll of the boat), to cause the automated boat lift to further lift the boat.

As yet another illustrative example, smart remote 12 may be configured to provide user customized home automation. For instance, a user may wish to automatically turn on one or more devices when people are present in the home and/or turn off one or more devices when the home is unoccupied.

A user may configure one or more smart remotes 12 to individually (or jointly via inter-communication of the smart remotes 12) determine whether a home is occupied or unoccupied based on vibration sensors, motion sensors, temperature sensors, proximity sensors, and/or any other sensor of smart remote 12 or communicatively connected thereto. The user may configure the one or more smart remotes 12 to perform one or more actions in response to determining the house is occupied or unoccupied. For instance, the user may configure the one or more smart remotes 12 to communicate control signals to control units 16 of one or more remote controlled devices 14, in response to determining the house is occupied or unoccupied.

Additionally or alternatively, user may configure one or more smart remotes 12 to perform one or more actions in response to detecting opening of a door to which a smart remote 12 is attached. For example, a parent may place smart remote 12 in a drawer in which sweet snack such as cookies are kept. The parent may program smart remote to communicate a text message alert to the parent when sensors indicate the drawer is opened to prevent children from sneaking snacks.

It is appreciated that smart remote system 10 is not limited to use with these limited example applications. Rather, it is contemplated that smart remote system 10 may be customized by a user for use in countless different applications.

Various blocks, modules, or other circuits may be implemented to carry out one or more of the operations and activities described herein and/or shown in the figures. In these contexts, a “block” (also sometimes “logic circuit” “control circuit,” “controller,” “module”, “device” or simply “circuit”) is an electrical circuit specifically configured and arranged to carry out one or more of these or related operations/activities. For example, control circuits may be discreet logic circuits or programmable logic circuits configured and arranged for implementing these operations/activities, as shown in the figures and/or described in the specification. In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of instructions (and/or configuration data). The instructions (and/or configuration data) can be in the form of firmware or software stored in and accessible, from a memory (circuit). Certain embodiments are directed to a computer program product (e.g., nonvolatile memory device), which includes a machine or computer-readable medium having stored thereon instructions which may be executed by a computer (or other electronic device) to perform these operation/activities, From the above discussion it will be appreciated that a remote control system 10 and related methods of use is presented herein improves upon the state of the art. More specifically, a remote control system 10 and related methods of use is presented that can be used to trigger actions of a remote controlled device; that is capable of independently controlling different remote controlled devices; that can be programed to control third party remote controlled devices; that can be programed to trigger various actions specified by a user in response to sensor data satisfying trigger conditions specified by the user; that is power efficient; that is user friendly; that provides improved functionality; that is easy to program; that is relatively inexpensive; that has a minimum number of parts; that has an intuitive design; that is intuitive to install; that has an installation that is quick; that expands functionality of remote controlled devices; that is durable; and/or that has a long useful life. These and other objects, features, or advantages of the present disclosure will become apparent from the specification and claims.

What is claimed:

1. A smart remote system, comprising
a body;
the body having a front side, a back side, and an exterior peripheral edge;
one or more sensors positioned within in the body;
a control circuit positioned within in the body;
the control circuit communicatively connected to the one or more sensors;
wherein the control circuit is configured and arranged to:
receive data from the one or more sensors;
compare the data received from the one or more sensors to one or more trigger conditions specified in a configuration data file associated with the control circuit; and
in response to the data satisfying a first trigger condition of the one or more trigger conditions, performing one or more actions specified in the configuration data file for the first trigger condition.

2. The system of claim 1, wherein the one or more actions specified in the configuration data file for the first trigger condition includes transmitting a command message to a remote controlled device communicatively connected to the control circuit.

3. The system of claim 1, wherein the one or more actions specified in the configuration data file for the first trigger condition includes transmitting a text message specified in the configuration data file to a phone number specified in the configuration data file.

4. The system of claim 1, wherein the one or more actions specified in the configuration data file for the first trigger condition includes transmitting an email message specified in the configuration data file to an email address specified in the configuration data file.

5. The system of claim 1, wherein the one or more actions specified in the configuration data file for the first trigger condition includes transmitting a message specified in the configuration data file to a device specified in the configuration data file.

6. The system of claim 1, further comprising a user interface;
the user interface including a display and one or more inputs;
the user interface configured to permit a user to specify, in the configuration data file, pairs of trigger conditions and actions to be performed when trigger conditions are satisfied.

7. The system of claim 1, further comprising a user interface;
the user interface positioned on an exterior surface of the body;
the user interface configured to permit a user to specify, in the configuration data file, sets of trigger conditions and actions to be performed when trigger conditions are satisfied.

8. The system of claim 1, further comprising a user interface;
the user interface positioned on an exterior surface of the body;
the user interface including a display and one or more inputs;
the user interface configured to permit a user to specify, in the configuration data file, sets of trigger conditions and actions to be performed when trigger conditions are satisfied.

9. The system of claim 1, further comprising a user interface;
the user interface configured to permit a user to specify, in the configuration data file, sets of trigger conditions and actions to be performed when the trigger conditions are satisfied;
wherein the user interface is a computing device communicatively connected to the control circuit.

10. The system of claim 1, wherein the one or more trigger conditions are specified as Boolean states of the one or more sensors.

11. The system of claim 1, wherein the one or more trigger conditions are specified as Boolean logic functions of the data from the one or more sensors.

12. The system of claim 1, wherein the control circuit includes:
a memory;
a configuration data file stored in the memory;
a communication circuit;
a processing circuit communicatively connected to the one or more sensors, the memory and the communication circuit;
wherein the processing circuit is configured and arranged to
receive the data from the one or more sensors;
compare the data received from the one or more sensors to one or more trigger conditions specified in the configuration data file; and in response to the data satisfying a first trigger condition of the one or more trigger conditions, cause the communication circuit to transmit a command message indicated in the configuration data file for the first trigger condition.

13. The system of claim 1, wherein the front side, the back side, and the exterior peripheral edge of the body form a hollow interior housing the one or more sensors and control circuit.

14. The system of claim 1, wherein the body is a solid body encasing the one or more sensors and control circuit.

15. A method for controlling a remote controlled device, comprising:
providing a smart remote;
wherein the smart remote has a body, one or more sensors positioned within in the body, and a control circuit positioned within in the body;
using the control circuit, receiving data from the one or more sensors;
using the control circuit, comparing the data received from the one or more sensors to one or more trigger conditions specified in a configuration data file stored in a memory of the smart remote; and
using the control circuit, in response to the data satisfying a first trigger condition of the one or more trigger conditions, performing one or more actions specified in the configuration data file for the first trigger condition.

16. The method of claim 15, wherein the performing of the one or more actions includes transmitting a command message to a remote controlled device communicatively connected to the control circuit.

17. The method of claim 15, wherein the performing of the one or more actions includes transmitting a text message specified in the configuration data file to a phone number specified in the configuration data file.

18. The method of claim 15, wherein the performing of the one or more actions includes transmitting an email message specified in the configuration data file to an email address specified in the configuration data file.

19. The method of claim 15, wherein the performing of the one or more actions includes transmitting a message specified in the configuration data file to a device specified in the configuration data file.

20. The method of claim 15, wherein the smart remote includes a user interface; and
further comprising using the user interface to specify the first trigger condition and the one or more actions in the configuration data file.

21. The method of claim 15, wherein the smart remote includes a user interface;
the user interface is positioned on an exterior surface of the body;
the user interface includes a display and one or more inputs; and
further comprising using the user interface to specify the first trigger condition and the one or more actions in the configuration data file.

22. The method of claim 15, further comprising using a user interface on a computing device communicatively connected to the smart remote to specify the first trigger condition and the one or more actions in the configuration data file.

23. A smart remote system for detecting tilting, comprising
a remote control;
the remote control having a body;
the remote control having one or more sensors;
the remote control having a control circuit;
the remote control having a communication circuit:
the control circuit of the remote control communicatively connected to the one or more sensors of the remote control and the communication circuit of the remote control;
wherein the control circuit and associated one or more sensors is configured and arranged to detect tilting;
a motorized window covering;
the motorized window covering having a motor;
the motorized window covering having a bottom bar;
the motorized window covering having a control circuit;
the motorized window covering having a communication circuit;
the control circuit of the motorized window covering communicatively connected to the communication circuit of the remote control;
wherein the remote control is connected to the bottom bar of the motorized window covering;
wherein when the remote control detects tilting beyond a first threshold, the remote control transmits a wireless signal through the communication circuit of the remote control over the air to the communication circuit of the motorized window covering thereby indicating the tilted condition of the bottom bar to the control circuit of the motorized window covering.

24. The method of claim 23, wherein the remote control is attached to the bottom bar of the motorized window covering.

25. The method of claim 23, wherein the remote control is positioned within a hollow interior of the bottom bar of the motorized window covering.
